(19) United States
(12) Patent Application Publication
(10) Pub. No.: US 2026/0321029 A1
(43) Pub. Date: Oct. 15, 2026

(54) Processing Method and Host for Reducing Image Detection Errors

(71) Applicant: AutoSys (TW) Co., Ltd., Zhubei City (TW)

(72) Inventors: Jui-Li Chen, Zhubei City (TW); Jun-Yao Zhong, Zhubei City (TW); Bo-Yu Chen, Zhubei City (TW); Tse-Min Chen, Zhubei City (TW)

(21) Appl. No.: 19/176,261

(22) Filed: Apr. 11, 2025

(51) Int. Cl. G06V 20/59; G06V 10/25; G06V 10/764; G06V 10/82

(52) U.S. Cl. CPC G06V 20/597; G06V 10/25; G06V 10/764; G06V 10/82

(57) ABSTRACT

A processing method for reducing image detection errors includes classifying a ROI of an image by an object detection model to look for a pixel area corresponding to first kind objects and a pixel area corresponding to second kind objects; comparing the pixel area corresponding to the first kind objects with multiple first exemplary masks corresponding to the first kind objects to get a first determination result; comparing the pixel area corresponding to the second kind objects with multiple second exemplary masks corresponding to the second kind objects to get a second determination result; and based on the first and the second determination results, determining whether the ROI contains one of the second kind objects.

### FIELD OF THE INVENTION

The present invention relates to driving safety, and more particularly, to image monitoring mechanism for driver attentiveness.

### BACKGROUND OF THE INVENTION

Recently, the technologies of assistive or autonomous vehicular driving progress significantly. Due to the improvements of yield rate of SOC (system on a chip), vehicular recognition, sensing, and controlling systems advance in a large leap, more reliable and safer fully automatic driving vehicles are coming. However, before the ideal vehicles are realized, the drivers of vehicles cannot be absent.

In order to ensure the safety of vehicles, one of the important factors is the attentive level of driver, which further includes a recognition part and a visual part. The accident analysis reports regarding to Europe, United States, and Australia between 2019 and 2021 show that around 17% of fatal vehicular accidents is originated from driver distractions and/or inattention. According to the suggestions provided by United States Center for Disease Control and Prevention, the driver distractions can be classified into three categories: visual distractions (eyes off events), manipulative distractions (hands off events), and mental distractions (attentive deviation events). Examples of driver distractions include interactions with passengers, using telephone, looking at vehicular interior or exterior environments, eating, drinking, singing, dancing, making up, smoking, operating devices, and taking something. The mentioned distractions result in longer responsive time, delays of adequate planning and decisive control. It highlights the demands of DMS, Driver Monitoring System. Based on the events detected by sensors, DMS is configured to generate feedback to inform the driver when his/her attentive level is lower than a certain threshold. The feedback may include acoustic, visual and/or tactile warning messages.

Traditional DMS performs image detection of hand phones and cigarettes. However, volumes of hand phones and cigarettes are not large enough, the proportion of corresponding pixels with regard to the whole image is quite small. It usually cannot detect hand phones and cigarettes in image detection.

Another traditional DMS performs image detection of hand-held phones and hand-held cigarettes. Although the detection rate is raised, false alarms often occur when the driver holds or scratches his/her face by hand, because the hand attitude is very similar to holding phones and cigarettes. After the false alarm occurs, the DMS may adopt following feedback mechanisms to remind the driver including shaking seat, vibrating safety belt, sounding alarm or light prompts. The DMS may interfere the vehicular control such deaccelerating or blinking lights. Comparing with the situation fails to detect hand phones and cigarettes, the false alarms discomfort the driver and influence his/her mood.

As a result, it is required to have a processing method for reducing image detection errors. It cannot only increase the detection rate of small objects but also reduce the false alarm rates to enhance the reliability of DMS.

### SUMMARY OF THE INVENTION

According to an embodiment of the present application, a processing method for reducing image detection errors is provided. The method comprises: classifying a ROI (region of interest) of an image by an object detection model to look for a pixel area corresponding to first kind objects and a pixel area corresponding to second kind objects; comparing the pixel area corresponding to the first kind objects with multiple first exemplary masks corresponding to the first kind objects to get a first determination result which indicates that whether the pixel area corresponding to the first kind objects does correspond to one of the first kind objects; comparing the pixel area corresponding to the second kind objects with multiple second exemplary masks corresponding to the second kind objects to get a second determination result which indicates that whether the pixel area corresponding to the second kind objects does correspond to one of the second kind objects; and based on the first and the second determination results, determining whether the ROI contains one of the second kind objects.

Preferably, in order to get the ROI, the processing method further comprises receiving the image; and detecting the first kind objects in the image for obtaining the ROI by using the object detection model.

Preferably, in order to get the first determination result, wherein the step of comparing the pixel area corresponding to the first kind objects with multiple first exemplary masks corresponding to the first kind objects further comprises: calculating first likelihoods between a shape context of the pixel area corresponding to the first kind objects and shape contexts of the multiple first exemplary masks, respectively; and when one of the first likelihoods exceeds a first threshold, the first determination result is set as true; otherwise, the first determination result is set as false.

Preferably, in order to get the second determination result, wherein the step of comparing the pixel area corresponding to the second kind objects with multiple second exemplary masks corresponding to the second kind objects further comprises: calculating second likelihoods between a shape context of the pixel area corresponding to the second kind objects and shape contexts of the multiple second exemplary masks, respectively; and when one of the second likelihoods exceeds a second threshold, the second determination result is set as true; otherwise, the second determination result is set as false.

Preferably, in order to obtain the first and the second exemplary masks, wherein the multiple first exemplary masks and the multiple second exemplary masks are selected from a training set of the object detection model.

Preferably, in order to get better object detection effects, wherein the object detection model includes a neck network implemented in GhostPAN architecture.

Preferably, in order to prevent the model ignoring small sized object area and downgrading the preciseness of image segmentation when positive and negative samples are severely imbalanced, wherein the object detection model is trained with Dice loss as its loss function.

Preferably, in order to prevent false alarm, wherein when the first and the second determination results are both true, it is determined that the ROI does include the second kind objects; and when the first determination result is true and the second determination result is false, it is determined that the ROI does not include the second kind objects.

Preferably, in order to increase the detection probability of the second kind objects, wherein when the first determination result is false and the second determination result is true, it is determined that the ROI does include the second kind objects.

Preferably, in order to be adopted in DMS, wherein the image is related to a front face of a driver who is in control of a vehicle, wherein the first kind objects include one or any combination of following: hand, leg, and a face of a man other than the driver, wherein the second kind objects include one or any combination of following: hand phone; cigarette; cup; bottle; food; food package; eyebrow pen; cosmetic mirror; cosmetic cotton; handkerchief; and tissues.

Preferably, in order to prompt the driver, wherein when the ROI does include the second kind objects, the processing method further comprises transmitting one of following prompts: visual prompt; acoustic prompt; and haptic prompt. The haptic prompt includes vibrations or shakings of handling wheel, chair, safety belt, or control device of the driver.

According to an embodiment of the present application, a host for reducing image detection errors is provided. The host comprises at least one processor to executes instructions stored in non-volatile memory to fulfill the processing method for reducing image detection errors.

According to the processing method and the host for reducing image detection errors provided by the present application, it can reduce errors on image determinations. Moreover, it can not only increase the detection probability of small-scale object but also reduce the false alarm rate. Thus, the image detection and/or the reliability of DMS can be enhanced.

### BRIEF DESCRIPTION OF THE DRAWINGS

The advantages and spirit related to the present invention can be further understood via the following detailed description and drawings.

FIG. 1 shows a diagram of a driver monitoring system 100 in accordance with an embodiment of the present application.

FIG. 2 shows a block diagram of the DMS 100.

FIG. 3 illustrates a flowchart diagram of a processing method for reducing image detection error in accordance with an embodiment of the present application.

FIG. 4 depicts illustrative diagrams of classified pixel areas in the region of interest in accordance with an embodiment of the present application.

### DETAILED DESCRIPTION OF THE PREFERRED EMBODIMENT

Some embodiments of the present application are described in detail below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

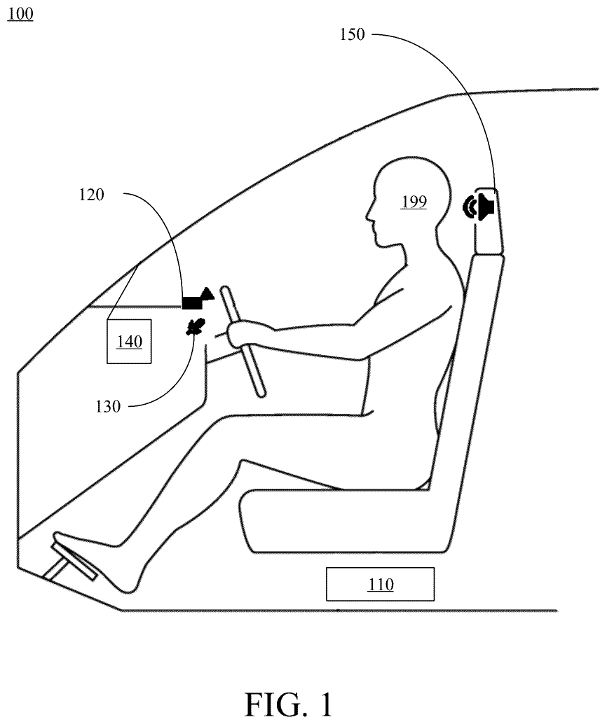

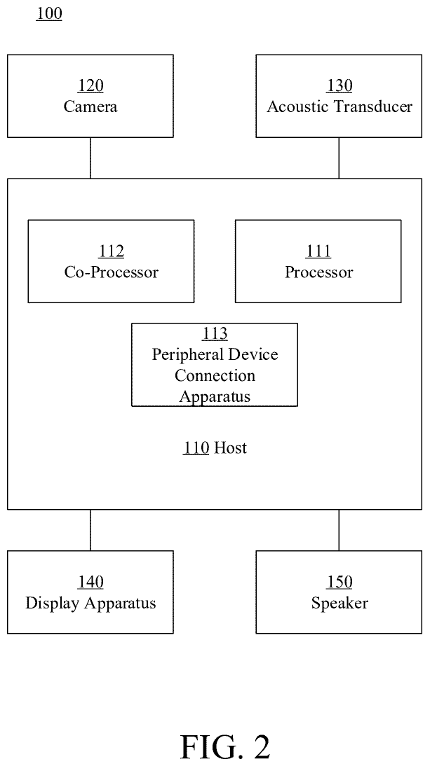

Please refer to FIG. 1, which shows a DMS (driver monitoring system) 100 in accordance with an embodiment of the present application. Please refer to FIG. 2 which shows a block diagram of the DMS 100. Although the DMS 100 as shown in FIG. 1 is installed inside a car, person having ordinary skill in the art can understand that the DMS 100 may be applicable to all kinds of transporters such as motorcycles, tricycles, airplanes, vessels, spacecrafts etc. given the vehicle is controlled by at least one driver 199.

The DMS 100 comprises a host 110 as well as at least one camera 120, at least one acoustic transducer 130, at least one display apparatus 140, and at least one speaker 150. As shown in FIG. 1, the field of view of the camera 120 at least points to the face of the driver 199. The acoustic receiving region of the acoustic transducer 130 includes the mouth of the driver 199. The driver 199 is able to see the visual content shown by the display apparatus 140 and to hear the acoustic signal transmitted by the speaker 150. In one embodiment, the display apparatus 140 may include a HUD (head up display) installed in front of the driver 199. In one embodiment, the speaker 250 is installed in the head rest behind the head of the driver 199.

In one embodiment, the display apparatus 140 may include a forward-looking HUD. In other embodiments, the display apparatus 140 may include a virtual reality, an augmented reality, or a mixed reality display. Person having ordinary skill in the art can understand that the display apparatus 140 is only required to show a visual prompt the driver 199. In such case, a simple light apparatus is also a qualified display apparatus 140. Similarly, the speaker 150 is only required to transmit an acoustical prompt the driver. Even a simple buzzer can be a kind of speaker 150.

In some embodiments, the display apparatus 140 is not fully controlled by the DMS 100. For example, the display apparatus 140 may be an independent display which receives inputs from the DMS 100 and other systems and fuses the inputs from multiple sources together for display. Similarly, in some embodiments, the speaker 150 is not fully controlled by the DMS 100. For example, the speaker 150 may be an independent stereo machine which receives inputs from the DMS 100 and other systems and can synthesize the audio inputs from multiple sources together for play.

In one embodiment, the camera 120 may include a sensor covering IR (Infra-Red) band. In an alternative embodiment, the camera 12 may include one or more lights which emit energy in IR band. Therefore, the sensor covering IR band is capable to capture the face and facial features of the driver 199 in a low-illuminated environment. In one embodiment, the acoustic transducer 130 may have directional receiving function so as that it can point acoustically to the face of the driver 199, especially to the mouth for filtering outside noises. For example, the acoustic transducer 130 may include an array consisted of transducer elements. Thus, signal processing techniques can be applied to focus on or to scan the source or the direction of acoustic waves. Besides, one or more acoustic transducers 130 may be used to collect background noise in order to determine whether the collected sound is originated from the background noise or from the driver 199.

The host 110 may include one or more processors 111 in order to control the host 110 and the DMS 100. The processor 111 may execute an OS (operating system) as well as driver programs and application programs in the OS environment. The software and/or firmware including instructions and data for the processor 111 may be stored in non-volatile memory to fulfill the methods and functionalities provided by the present application. Person having ordinary skill in the art shall have knowledge of bachelor's degree which includes computer organization, computer architecture, operating system, system software etc. so as person having ordinary skill in the art can understand variants or derivates of hardware and software of the described host 110 applicable to the present application.

In order to accelerate the inferences of AI (artificial intelligence) and/or neural network models for monitoring the driver in real time, the host 110 may include one or more co-processors 112 for providing vectorized and scalar arithmetic and logic operating capabilities. The neural network models may include one or more species of DNNs (deep neural networks) or a collection of their derivates or variants. The types of neural network models may include CNN (Convolutional Neural Network) and its derivates or variants. The co-processor 112 may be general purposed or tailor-made GPU (graphical processing unit) and/or NPU (Neural network processor unit). Person having ordinary skill in the art can understand this kind of co-processors used in edge computing is already well-adopted in practices. Hence no further elaboration is provided here.

The host 110 may further comprise one or more peripheral-device connection apparatus 113 for connecting the at least one camera 120, the at least one acoustic transducer 130, the at least one display apparatus 140 and the at least one speaker 150. The peripheral-device connection apparatus 113 may include one or more interfaces compatible with one or more industrial standards such as blue-tooth, USB, IEEE 1394, UART, ISCSI, SATA, PCI-Express, PCT etc. or proprietary interfaces.

The DMS 100 provided by the present application utilizes visual sensor such as camera 120 to evaluate the driver's visual attentive level and audio sensor such as acoustic transducer 130 to evaluate the driver's recognition attentive level. Based on multiple mode information including fused visual and acoustic information, the DMS 100 provided by the present application can inference the visual and the recognition attentive level of the driver.

Unlike the traditional DMS which only analyzes the attentive levels of the driver based on optical sensors, the DMS 100 provided by the present application can provide more reliable driver's attentive level information. The DMS 100 provided by the present application can evaluate the visual attentiveness of the driver 199 according to the image contains the driver's face. The evaluation can include an algorithm to calculate the directions of the driver's head and eyes. In order to evaluate the driver's recognition attentive level, the evaluation may use an algorithm to detect acoustic events based on the received sounds. The acoustic events can be categorized into different types. For example, the algorithm can determine whether the driver is in a noisy environment or in a distractive environment. At last, when it is determined that the attentive level of the driver is too low based on the visual and the recognition attentiveness, it may notify or warn the driver through the display apparatus 140 and/or the speaker 150.

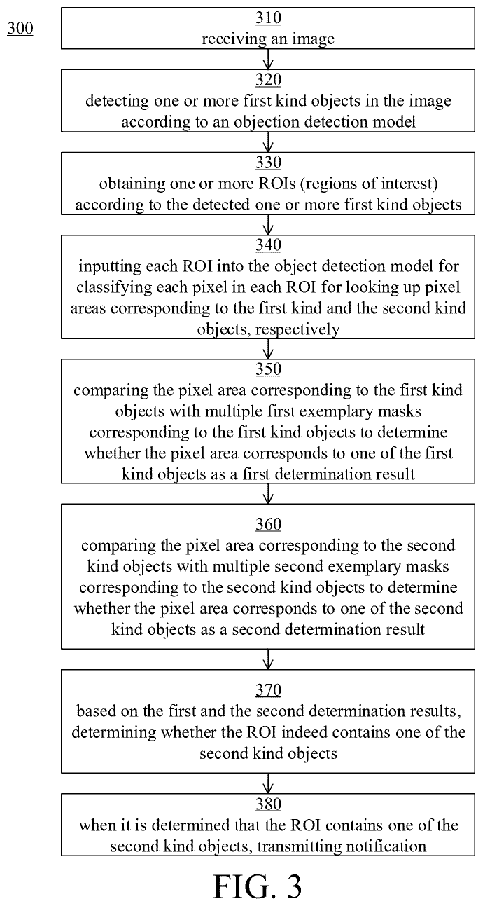

Please refer to FIG. 3 which depicts a flowchart diagram of a processing method 300 for reducing image detection error in accordance with an embodiment of the present application. The processing method 300 for reducing image detection error may be realized by the DMS 100 as shown in

FIGS. 1 and 2, especially be realized by the program executed by the host 110. For example, the program may be executed by the processor 111 and the co-processor 112. If there is no causal relationship between two steps, the present application does not limit the execution sequence of these two steps. The processing method 300 for reducing image detection error may begin at step 310.
Step 310: receiving an image, which may be originated from the camera 120.
Step 320: detecting one or more first kind objects in the image according to an objection detection model. The first kind objects may include hand, leg, and face profile. When detecting the first kind objects, one or more second kind objects which may influence the driver's attentive levels may be also being detected. For example, the second kind objects may include hand phone, cigarette, cup, bottle, food, food package, eyebrow pen, makeup mirror, cosmetic cotton, handkerchief, and toilet tissue etc.

Person having ordinary skill in the art can understand that the object detection model may be a common object detection model such as various versions of YOLO (You Only Look Once) or any CNN (Convolutional Neural Network) models. In one embodiment, the object detection model is a variant or a derivate of the YOLO models. For example, the neck network of the YOLO model may be configured as a GhostPAN architecture which is primarily based on concepts of Ghost module and PAN (Path Aggregation Network). The Ghost module usually extracts basic features by utilizing a part of standard CNN model or a depth-wise convolution model. Next, a cheaper or lighter linear transformation such as 1×1 convolution or other lightweighted operation is adopted to reduce computation quantity. In an object detection or segmentation system, a main purpose of the PAN is to provide two-way fusions of multi-layer features extracted by the backbone network of the YOLO model. The two-way fusions include top-down and opposite bottom-up fusions to enhance information flows between features in different layers.

In one embodiment, the object detection model may use Dice loss as its loss function. Dice loss is disclosed in a paper “V-net: Fully Convolutional Neural Networks for Volumetric Medical Image Segmentation” contributed by Fausto Milletari et al. It is originated from Sorensen-Dice coefficient. Most loss functions used in the training processes of DNNs for image segmentation are cross-entropy or its variants as main loss functions. However, in case severely imbalance of positive and negative samples resulting in highly concentrated data, small sized object areas would be ignored by the model if cross entropy is relied upon as loss function. In order to resolve this kind of problem, DSC (Dice Similarity Coefficient) or Dice-like coefficient which is a measurement function to evaluate likelihood of two samples, can be introduced. The value range of this function is between 0 and 1. Larger value indicates greater similarity. Dice loss function is calculated as 1 minus the DSC.

According to an embodiment of the present application, the learning method of the object detection model using Dice loss is provided below. At first, images and their corresponding labels in a training set are inputted into the object detection model for initializing the network parameters. Next, prediction probabilities and true labels are obtained. This step comprises gathering object probability p corresponding to each pixel and the ground truth label yᵢ through forward propagation. Next, the DSC is calculated accordingly. In a binary segmentation, the DSC can be calculated as following:

$$DSC = \frac{2 {\sum }_{i = 1}^{N} {p}_{i} {y}_{i} + ε}{{\sum }_{i = 1}^{N} {p}_{i} + {\sum }_{i = 1}^{N} {y}_{i} + ε} \qquad Equation ( 1 )$$

where pᵢ and yᵢ represents predict and ground truth values (or probabilities), respectively, N is the number of pixels, & is a smooth term for preventing the denominator as 0.

Based on the calculated DSC, the Dice loss can be calculated as following:

$$Dice loss = 1 - DSC , or \qquad Equation ( 2 )$$

$$Dice loss = 1 - \frac{2 {\sum }_{i = 1}^{N} {p}_{i} {y}_{i} + ε}{{\sum }_{i = 1}^{N} {p}_{i} + {\sum }_{i = 1}^{N} {y}_{i} + ε}$$

Through the training method, it can efficiently train a neural network model capable of precise segmentation for small sized objects or severely imbalanced object area. Thus, the correctness and reliability of the object detection model are improved.

When one of the first kind objects is detected at step 320, the flow may proceed to step 330. If no first kind object is detected at step 320, the flow may end.
Step 330: obtaining one or more ROIs (regions of interest) according to the detected first kind object(s). The ROI is usually rectangular. It is a part of the received image.
Step 340: inputting each ROI into the object detection model for classifying each pixel in each ROI for looking up pixel areas corresponding to the first kind and the second kind objects, respectively.

In one embodiment of the present application, one or two quantitative indicators including Disc and mIOU (mean intersection over union) are used for classification evaluation. As described above, the DSC is primarily configured for evaluating overlapping proportion between two sets, i.e., the prediction pixel area and ground truth pixel area. The value of DSC is between 0 and 1. One means that two sets are identical. Zero means that two sets are completely non-overlapping. In the field of image segmentation, assuming set A as the ground truth pixel area and set B as the prediction pixel area, the DSC can be calculated as follows:

$$DSC ( A , B ) = \frac{2 \times \vert A ⋂ B \vert}{\vert A \vert + \vert B \vert} \qquad Equation ( 3 )$$

where |A∩B| represents the intersection of the sets A and B, i.e., the number of pixels which are classified into a category, the |A| and |B| represent the number of pixels of the sets A and B, respectively.

Mean Intersection Over Union (mIOU) is a quantitative indicator usually applied to multiple category segmentation problems. At first, IOU (intersection over union) corresponding to each category is calculated. Subsequently, an average value of the intersection over union values corresponds to all categories is calculated. With regard to multiple category segmentation problems, mIOU can be used to represent segmentation qualities corresponding to each category. Assuming A_{c} represents a pixel area where category c is in the ground truth set A and assuming B_{c} represents a pixel area where category c is determined in the prediction set B, the IOU corresponding to the category c can be calculated as follows:

$${IOU}_{c} = \frac{\vert {A}_{C} ⋂ {B}_{C} \vert}{\vert {A}_{C} ⋃ {B}_{C} \vert} \qquad Equation ( 4 )$$

where |A_{C}∩B_{C}| represents the pixel number of intersection between the ground truth set and the prediction set corresponding to the category c, |A_{C}∪B_{C}| represents the pixel number of union between the ground truth set and the prediction set corresponding to the category c.

If there are C categories (may or may not include background), the mIOU value can be defined as follows:

$$mIOU = \frac{1}{C} {\sum }_{c = 1}^{C} {IOU}_{c} \qquad Equation ( 5 )$$

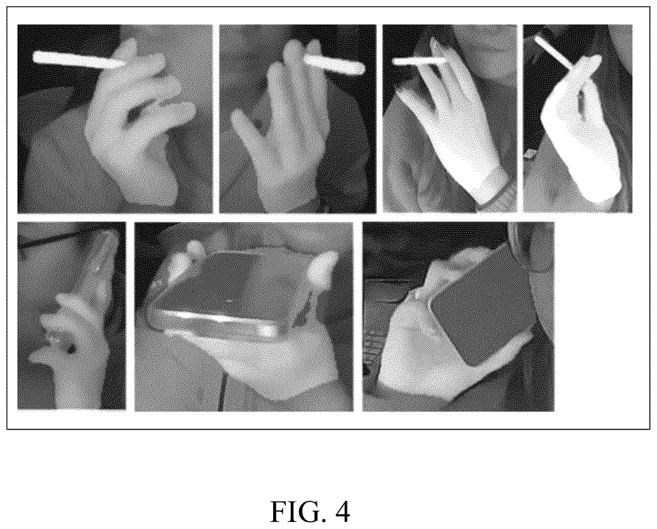

Please refer to FIG. 4, which depicts illustrative diagrams of classified pixel areas corresponding to regions of interest in accordance with an embodiment of the present application. In the embodiments as shown in FIG. 4, there are first-kind objects (e.g., hands), second-kind objects (e.g., cigarettes and hand phones), and background. The pixel area being classified as hand phones is painted in blue or dark grey. The pixel area being classified as cigarettes is painted in white. The pixel area being classified as hands is painted in pink or light grey. Other pixels belong to background.

According to one embodiment provided by the present application, the object detection model is evaluated by the Dice co-efficient and mIOU. Please refer to Table 1 as follows:

TABLE 1
segmentation accuracy of the object detection model

| | |
|---|---|
| Dice | 95.4% |
| mIOU | 90.2% |

Step 350: comparing the pixel area corresponding to the first kind objects with multiple first exemplary masks corresponding to the first kind objects to determine whether the pixel area corresponds to one of the first kind objects as a first determination result.

All the first exemplary masks correspond to the first kind objects. Likelihoods of samples in the training data set of the object detection model with the features of the first kind objects can be calculated by comparisons. The first exemplary masks corresponding to samples similar with the first kind objects are picked up as representatives accordingly. In one embodiment, the likelihoods can be determined by shape context calculation, which is a classic method for comparing 2D (2-dimensional) shapes or contours. Furthermore, the likelihoods may be calculated according to 3D (3-dimensional) cloud dots or similar scenarios.

The first step of the shape context calculation is to extract contour points which are discrete points sampled from 2D mask or boundary points of the object extracted from the image. In the second step, local shape descriptions are constructed subsequently. With respect to each discrete points, distance and direction distributions in which each point relative to other points are determined to form a statistical histogram with regard to logarithmic radius and ranges, which is referred to as shape context.

In case it happens to determine whether two shapes are matched or not, two shape contexts correspond to these two shapes are determined at first. Next, based on methods for matching these two shape contexts, a point correspondence relationship having minimum match errors can be found subsequently. The accumulated total error of the match result is a sum of weighted distances between corresponding points. It can be used to determine the likelihood between these two shapes. Person having ordinary skill in the art can understand that the shape context method is a well-known method to determine the likelihood between two shapes.

In this step, a first threshold can be predetermined. When the likelihood between the shape of the pixel area corresponding to the first kind objects and one of the shapes of the first exemplary masks exceed the first threshold, it is determined that the pixel area corresponds to one of the first kind objects, i.e., the first determination result is determined as true. If none of the likelihoods between the shape of the pixel area corresponding to the first kind objects and the shapes of the first exemplary masks does not exceed the first threshold, it is determined that the pixel area does not correspond to the first kind objects, i.e., the first determination result is determined as false.
Step 360: comparing the pixel area corresponding to the second kind objects with multiple second exemplary masks corresponding to the second kind objects to determine whether the pixel area corresponds to one of the second kind objects as a second determination result. Similarly, the second exemplary masks are corresponding to the second kind objects. Likelihoods of samples in the training data set of the object detection model with the features of the second kind objects can be calculated by comparisons. The second exemplary masks corresponding to samples similar with the second kind objects are picked up as representatives accordingly.

In this step, a second threshold can be predetermined. When the likelihood between the shape of the pixel area corresponding to the second kind objects and one of the shapes of the second exemplary masks exceed the second threshold, it is determined that the pixel area corresponds to one of the second kind objects, i.e., the second determination result is determined as true. If none of the likelihoods between the shape of the pixel area corresponding to the second kind objects and the shapes of the second exemplary masks does not exceed the second threshold, it is determined that the pixel area does not correspond to the second kind objects, i.e., the second determination result is determined as false.
Step 370: based on the first and the second determination results, determining whether the ROI indeed contains one of the second kind objects. When both the first and the second determination results are true, it is determined that the ROI does contain one of the second kind objects. When the first determination result is true, but the second determination result is false, it is determined that the ROI does not contain any of the second kind objects. Thus, false alarm could be reduced as a result.

When the first determination result is false, but the second determination result is true, i.e., at least one of the second kind objects such as hand phone and cigarette is detected, rather than any of the first kind objects such as hands. It may be caused by one of the second kind objects is placed somewhere and the driver does not take the one of the second kind objects (hand phone or cigarette) by hand. Or because the movement of the vehicle results in one of the second kind objects flies up. In some embodiment, even though a second kind object is detected, it may be determined that the ROI does not contain any of the second kind objects. Person having ordinary skill in the art can understand, when the first determination result is set as false but the second determination result is set as true, it may be determined that the ROI does contain one of the second kind objects in order to increase the probability of detection of the second kind object.
Step 380: when it is determined that the ROI contains one of the second kind objects, transmitting notification. Person having ordinary skill in the art can understand that the notification may include transmitting visual prompt by the display apparatus 140 or lights, acoustic prompt by the speaker 150, and signals to one or more outside systems (e.g., DMS) via one or more electronic interfaces.

According to an embodiment of the present application, a processing method for reducing image detection errors is provided. The method comprises: classifying a ROI (region of interest) of an image by an object detection model to look for a pixel area corresponding to first kind objects and a pixel area corresponding to second kind objects; comparing the pixel area corresponding to the first kind objects with multiple first exemplary masks corresponding to the first kind objects to get a first determination result which indicates that whether the pixel area corresponding to the first kind objects does correspond to one of the first kind objects; comparing the pixel area corresponding to the second kind objects with multiple second exemplary masks corresponding to the second kind objects to get a second determination result which indicates that whether the pixel area corresponding to the second kind objects does correspond to one of the second kind objects; and based on the first and the second determination results, determining whether the ROI contains one of the second kind objects.

Preferably, in order to get the ROI, the processing method further comprises receiving the image; and detecting the first kind objects in the image for obtaining the ROI by using the object detection model.

Preferably, in order to get the first determination result, wherein the step of comparing the pixel area corresponding to the first kind objects with multiple first exemplary masks corresponding to the first kind objects further comprises: calculating first likelihoods between a shape context of the pixel area corresponding to the first kind objects and shape contexts of the multiple first exemplary masks, respectively; and when one of the first likelihoods exceeds a first threshold, the first determination result is set as true; otherwise, the first determination result is set as false.

Preferably, in order to get the second determination result, wherein the step of comparing the pixel area corresponding to the second kind objects with multiple second exemplary masks corresponding to the second kind objects further comprises: calculating second likelihoods between a shape context of the pixel area corresponding to the second kind objects and shape contexts of the multiple second exemplary masks, respectively; and when one of the second likelihoods exceeds a second threshold, the second determination result is set as true; otherwise, the second determination result is set as false.

Preferably, in order to obtain the first and the second exemplary masks, wherein the multiple first exemplary masks and the multiple second exemplary masks are selected from a training set of the object detection model.

Preferably, in order to get better object detection effects, wherein the object detection model includes a neck network implemented in GhostPAN architecture.

Preferably, in order to prevent the model ignoring small sized object area and downgrading the preciseness of image segmentation when positive and negative samples are severely imbalanced, wherein the object detection model is trained with Dice loss as its loss function.

Preferably, in order to prevent false alarm, wherein when the first and the second determination results are both true, it is determined that the ROI does include the second kind objects; and when the first determination result is true and the second determination result is false, it is determined that the ROI does not include the second kind objects.

Preferably, in order to increase the detection probability of the second kind objects, wherein when the first determination result is false and the second determination result is true, it is determined that the ROI does include the second kind objects.

Preferably, in order to be adopted in DMS, wherein the image is related to a front face of a driver who is in control of a vehicle, wherein the first kind objects include one or any combination of following: hand, leg, and a face of a man other than the driver, wherein the second kind objects include one or any combination of following: hand phone; cigarette; cup; bottle; food; food package; eyebrow pen; cosmetic mirror; cosmetic cotton; handkerchief; and tissues.

Preferably, in order to prompt the driver, wherein when the ROI does include the second kind objects, the processing method further comprises transmitting one of following prompts: visual prompt; acoustic prompt; and haptic prompt. The haptic prompt includes vibrations or shakings of handling wheel, chair, safety belt, or control device of the driver.

According to an embodiment of the present application, a host for reducing image detection errors is provided. The host comprises at least one processor to executes instructions stored in non-volatile memory to fulfill the processing method for reducing image detection errors.

According to the processing method and the host for reducing image detection errors provided by the present application, it can reduce errors on image determinations. Moreover, it can not only increase the detection probability of small-scale object but also reduce the false alarm rate. Thus, the image detection and/or the reliability of DMS can be enhanced.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A processing method for reducing image detection errors, comprising:
classifying a ROI (region of interest) of an image by an object detection model to look for a pixel area corresponding to first kind objects and a pixel area corresponding to second kind objects;
comparing the pixel area corresponding to the first kind objects with multiple first exemplary masks corresponding to the first kind objects to get a first determination result which indicates that whether the pixel area corresponding to the first kind objects does correspond to one of the first kind objects;
comparing the pixel area corresponding to the second kind objects with multiple second exemplary masks corresponding to the second kind objects to get a second determination result which indicates that whether the pixel area corresponding to the second kind objects does correspond to one of the second kind objects; and
based on the first and the second determination results, determining whether the ROI contains one of the second kind objects.

2. The processing method of claim 1, further comprises:
receiving the image; and
detecting the first kind objects in the image for obtaining the ROI by using the object detection model.

3. The processing method of claim 1, wherein the step of comparing the pixel area corresponding to the first kind objects with multiple first exemplary masks corresponding to the first kind objects further comprises:
calculating first likelihoods between a shape context of the pixel area corresponding to the first kind objects and shape contexts of the multiple first exemplary masks, respectively; and
when one of the first likelihoods exceeds a first threshold, the first determination result is set as true; otherwise, the first determination result is set as false, and
wherein the step of comparing the pixel area corresponding to the second kind objects with multiple second exemplary masks corresponding to the second kind objects further comprises:
calculating second likelihoods between a shape context of the pixel area corresponding to the second kind objects and shape contexts of the multiple second exemplary masks, respectively; and
when one of the second likelihoods exceeds a second threshold, the second determination result is set as true; otherwise, the second determination result is set as false.

4. The processing method of claim 1, wherein the multiple first exemplary masks and the multiple second exemplary masks are selected from a training set of the object detection model.

5. The processing method of claim 1, wherein the object detection model includes a neck network implemented in GhostPAN architecture.

6. The processing method of claim 1, wherein the object detection model is trained with Dice loss as its loss function.

7. The processing method of claim 1, wherein
when the first and the second determination results are both true, it is determined that the ROI does include the second kind objects; and
when the first determination result is true and the second determination result is false, it is determined that the ROI does not include the second kind objects.

8. The processing method of claim 1, wherein when the first determination result is false and the second determination result is true, it is determined that the ROI does include the second kind objects.

9. The processing method of claim 1,
wherein the image is related to a front face of a driver who is in control of a vehicle, wherein the first kind objects include one or any combination of following: hand, leg, and a face of a man other than the driver, and
wherein the second kind objects include one or any combination of following: hand phone; cigarette; cup; bottle; food; food package; eyebrow pen; cosmetic mirror; cosmetic cotton; handkerchief; and tissues.

10. The processing method of claim 1, wherein when the ROI does include the second kind objects, the processing method further comprises transmitting one of following prompts:
visual prompt;
acoustic prompt; and
haptic prompt, which includes vibrations or shakings of handling wheel, chair, safety belt, or control device of the driver.

11. A host for reducing image detection errors, comprising at least one processor to execute instructions stored in non-volatile memory to fulfill the processing method of claim 1.

12. A host for reducing image detection errors, comprising at least one processor to execute instructions stored in non-volatile memory to fulfill the processing method of claim 2.

13. A host for reducing image detection errors, comprising at least one processor to execute instructions stored in non-volatile memory to fulfill the processing method of claim 3.

14. A host for reducing image detection errors, comprising at least one processor to execute instructions stored in non-volatile memory to fulfill the processing method of claim 4.

15. A host for reducing image detection errors, comprising at least one processor to execute instructions stored in non-volatile memory to fulfill the processing method of claim 5.

16. A host for reducing image detection errors, comprising at least one processor to execute instructions stored in non-volatile memory to fulfill the processing method of claim 6.

17. A host for reducing image detection errors, comprising at least one processor to execute instructions stored in non-volatile memory to fulfill the processing method of claim 7.

18. A host for reducing image detection errors, comprising at least one processor to execute instructions stored in non-volatile memory to fulfill the processing method of claim 8.

19. A host for reducing image detection errors, comprising at least one processor to execute instructions stored in non-volatile memory to fulfill the processing method of claim 9.

20. A host for reducing image detection errors, comprising at least one processor to execute instructions stored in non-volatile memory to fulfill the processing method of claim 10.
